(19) United States
(12) Patent Application Publication
(10) Pub. No.: US 2018/0121501 A1
(43) Pub. Date: May 3, 2018

(54) TRANSLATING GQL QUERIES INTO SQL QUERIES

(71) Applicant: HEWLETT PACKARD ENTERPRISE DEVELOPMENT LP, Houston, TX (US)

(72) Inventors: Luis Miguel Vaquero Gonzalez, Bristol (GB); Marco Aurelio Barbosa Fagnani Gomes Lotz, Bristol (GB)

(21) Appl. No.: 15/337,482

(22) Filed: Oct. 28, 2016

(51) Int. Cl. G06F 17/30

(52) U.S. Cl. CPC G06F 17/30427; G06F 17/30595

(57) ABSTRACT

Example embodiments relate to translate a GQL query into a SQL query. The example disclosed herein receives a graph query language (GQL) query, transforms the GQL query into a representation of an abstract syntactic structure of the GQL query, translates the representation of the abstract syntactic structure of the GQL query into a structured query language (SQL) query, and sends the SQL query to a relational database management system.

### BACKGROUND

Enterprises often store massive amounts of data in relational databases. Extracting the queried data in the most efficient manner could provide the enterprise with a competitive advantage and add significant value.

### BRIEF DESCRIPTION OF THE DRAWINGS

Features of the present disclosure are illustrated by way of example(s) and not limited in the following figure(s) in which like numerals indicate like elements, in which:

FIG. 1 is a block diagram illustrating a system for translating a graph query language (GQL) query into a structured query language (SQL) query, according to an example of the present disclosure.

FIG. 2 is a block diagram illustrating additional instructions of the system for translating a GQL query into a SQL query, according to an example of the present disclosure.

FIG. 3 is a schema of an abstract syntax tree structure breakdown, according to an example of the present disclosure.

FIG. 4A is a flowchart for a method for translating a GQL query into a SQL query, according to an example of the present disclosure.

FIG. 4B is a flowchart for a method for using a graph topology to translate the node or edge information to SQL, according to an example of the present disclosure.

FIG. 4C is a flowchart for a method for translating a leaf, according to an example of the present disclosure.

FIG. 5 is an illustration of a GQL-to-SQL dictionary, according to an example of the present disclosure.

FIG. 6 is a block diagram illustrating a system for translating a GQL query into a SQL query, according to an example of the present disclosure.

FIG. 7 is a flowchart illustrating a method for translating a GQL query into a SQL query, according to an example of the present disclosure.

### DETAILED DESCRIPTION

The following discussion is directed to various examples of the disclosure. The examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

As mentioned above, many enterprises often store massive amounts of data in relational databases. Extracting the queried data in the most efficient manner could provide the enterprise with a competitive advantage and add significant value as the database queries may be answered faster. Due to the previous, enterprises may extract database information faster, and therefore face challenges with an enhanced flexibility.

Structured Query Language (SQL) is commonly used to query relational databases managed by Relational Database Management Systems (RDBMS). Due to syntax structure of SQL language, some special queries may be difficult to implement and, when written, may generate long statements without a clear description of what is being performed. These complexities may be evident in most graph operations performed in RDBMSs, where a many sequential relational tables may need to be joined in order to run graph traversal examples. Furthermore, graph operations may demand a huge number of sequential table joins, which may be a very computationally expensive operation when run on large datasets.

Because of the previous technical challenges, Graph Database Management System (GDBMS) has been developed as an alternative to RDBMS. The term Graph Query Language (GQL) may be used to describe the set of languages that are used to query GDBMS. New mechanisms specialized in graph storage provide quick graph traversal operations associated with simple domain specific queries.

However, legacy relational databases (including relational databases, hierarchical databases, network databases, object databases, or any other suitable form of databases that allows interaction with Database Management System (DBMS), Relational Database Management System (RDBMS) or a combination thereof) raise a technical challenge to implementing GDBMS and GQL. The technical challenge arises as data from legacy relational databases would have to be ingested on slow translocations in the GDBMS in order to run GQL queries. Systems that were developed for RDBMS would have to be migrated to support nascent GDBMS. Also, research of distributed RDBMS systems would have to be reanalyzed in order to provide a similar feature on graph systems.

Some RDBMS systems implement graph processing by fixing a data schema inside the RDBMS for all the information that could be translated into a graph. However, this approach may require large amounts of data migration from the original relational database format to the graph format and, as a consequence, any update in either of the formats may cascade updates on the other.

Examples disclosed herein may relate to, among other things, translating a GQL query to a SQL query. In some implementations, a GQL query is received and transformed into a representation of an abstract syntactic structure of the GQL query. The representation of the abstract syntactic structure of the GQL query may be translated into a structured query language (SQL) query, which in turn may be sent to a relational database management system. A GQL-to-SQL dictionary file may be utilized in the translation. By virtue of translating a GQL query into a SQL query, complete graph processing capabilities may be applied to RDBMS, and with minimal or no modifications to the GQL language or to the RDBMS. Accordingly, GQL language, which may be deemed more intuitive for querying graph domains than SQL language, may be made more accessible to a broader user base (i.e., RDBMS users).

Moreover, examples disclosed herein may support both groups of GQL language: imperative GQL language and declarative GQL language. Imperative GQL language is based on traversal of graphs as it pattern matches the traversal needs to be anchored in a source and/or destination among the nodes in the graph (e.g. Gremlin and Unipop are example imperative GQL languages). Declarative GQL language may comprise a transformation of the query into an Abstract Syntax Tree (AST), creation of a query graph from the AST and execution the query (e.g. Cypher is an example declarative GQL language). For simplicity, examples described herein may be illustrated using a declarative GQL language as input, but it should be understood that such examples may also be compatible with imperative GQL language.

Additionally, examples disclosed herein may describe how the data stored in the RDBMS would be represented as a property graph, including classification of node types and edge types. The examples of the present disclosure may not assume that all information required to describe a node or an edge type is self-contained in a single table or follow a specific formation pattern. Furthermore, the examples of the present disclosure do not require data migration.

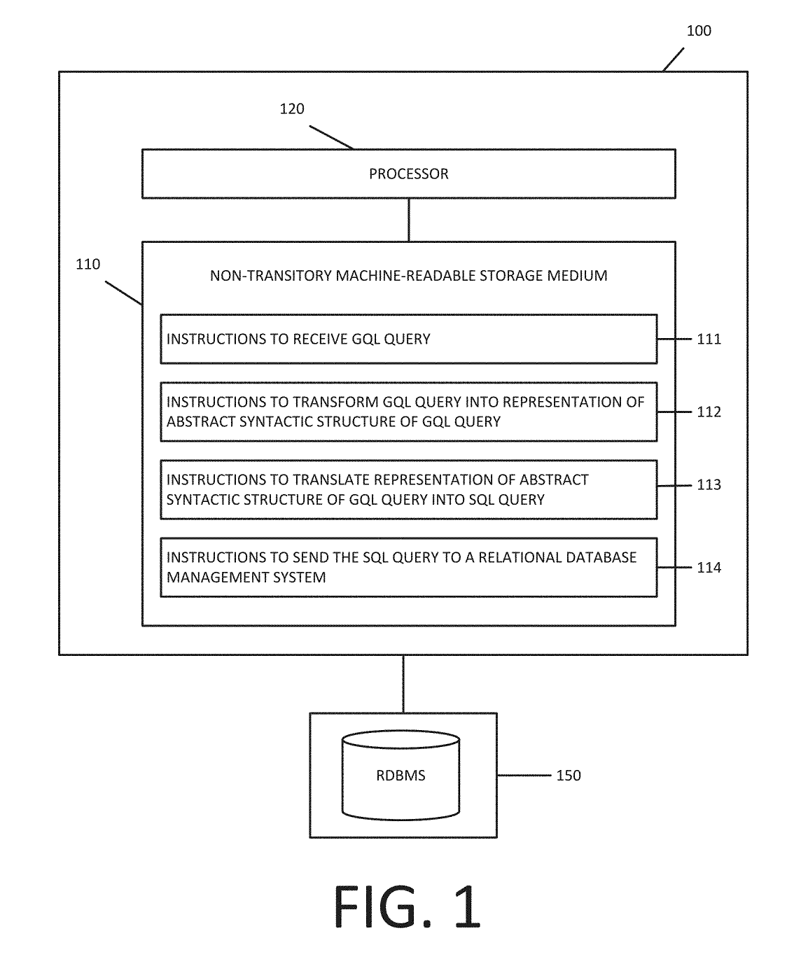

Referring now to the drawings, FIG. 1 is a block diagram illustrating a system for translating a graph query language (GQL) query into a structured query language (SQL) query, according to an example of the present disclosure.

FIG. 1 describes a system 100 that includes a physical processor 120 and a non-transitory machine readable storing medium 110. The non-transitory machine readable storage medium 110 comprises: instructions 111 to receive GQL query; instructions 112 to transform GQL query into representation of abstract syntactic structure of the GQL query; instructions 113 to translate representation of abstract syntactic structure of GQL query into SQL query; and instructions 114 to send the SQL query to a relational database management system. The instructions 111-114 may be executed by the processor 120 to perform the functionality described herein.

In an example, the instructions 111-114, and/or other instructions can be part of an installation package that can be executed by processor 120 to implement the functionality described herein. In such a case, non-transitory machine readable storage medium 110 may be a portable medium such as a CD, DVD, or flash device or a memory maintained by a computing device from which the installation package can be downloaded and installed. In another example, the program instructions may be part of an application or applications installed in the computer readable medium 100.

The non-transitory machine readable storage medium 110 may be any electronic, magnetic, optical, or other physical storage device that contains or stores executable data accessible to the computer readable medium 100. Thus, non-transitory machine readable storage medium 110 may be, for example, a Random Access Memory (RAM), an Electrically Erasable Programmable Read-Only Memory (EEPROM), a storage device, an optical disc, and the like. The non-transitory machine readable storage medium 110 does not encompass transitory propagating signals. Non-transitory machine readable storage medium 110 may be located in the system 100 and/or in any other device in communication with the system 100.

In some implementations, the system 100 may be in communication with a distributed database (RDBMS) that employs SQL natively. A user (e.g. a marketing department analyst) may want to check the distributed database for some requested data. As will be described, the system 100 may be useful for enabling a user to query for the requested data in GQL, which may be simpler and more intuitive for the user than SQL.

In the example of FIG. 1, the instructions 111, when executed by the processor 110, cause the processor 110 to receive a GQL query.

The instructions 112, when executed by the processor 110, cause the processor 110 to transform the GQL query (e.g., received by execution of instructions 111) into a representation of abstract syntactic structure of GQL query 112.

In the present disclosure, a representation of abstract syntactic structure of GQL may be understood as any mechanism that breaks down the GQL query into a source code, wherein the different elements from the query can be further extracted and analyzed independently. Some examples of a representation of abstract syntactic structure of GQL may be: Abstract Syntactic Tree (AST), Abstract Semantic Graph, Composite Pattern, Document Object Model, Naur Form, Lisp, Semantic Resolution Tree, Shunting yard algorithm, Symbol table, TreeDL, Term graph, etc. Example implementations described herein may use any representation of abstract syntactic structure of GQL query, but for simplicity and convenience, the examples disclosed herein may be based on AST. AST transforms a piece of text (e.g. a sentence in human languages) into a data structure such as a tree, and identifies the role of each part of the text in the sentence, like a syntactic analysis in human languages.

The GQL query may be transformed into an AST using a Parser module, which receives the GQL query input in the form of sequential source program instructions, interactive online commands, markup tags, or other defined interface, and breaks the query input into parts (e.g. nouns as objects and verbs as methods, etc.) that can be managed by other programming. Some examples of Parser modules may be: ANTLR, Lex, Syntax Definition Formalism, SYNTAX, XPL, Yacc, Coco/R, etc.

The instructions 113, when executed by the processor 110, cause the processor 110 to translate representation of abstract syntactic structure of GQL query generated by instructions 112 into a SQL query. The present disclosure may translate the representation of abstract syntactic structure of GQL query into a SQL query using a GQL-to-SQL dictionary file, also referred to herein as a “gTop” file. GTop file may be a graph topology file, which contains a map of nodes and edges. Based on the distribution of the different entities as nodes and the relationships between entities as edges, gTop file may act as a document that maps the graph topology elements such as nodes and edges into SQL node entities and SQL relationship entities, and therefore is a document that may provide a translation from nodes and edges in GQL language to entities and relationships between entities in SQL. The GQL-to-SQL dictionary file will be described in greater detail below. The instructions 114, when executed by the processor 110, cause the processor 110 to send the SQL query to a RDBMS. For example, once the system 100 has generated the SQL query from the GQL query, the SQL query is forwarded to the relational database management system, for which SQL may be the native query language. Then, the RDBMS may process the SQL query and return the resultant information to the user.

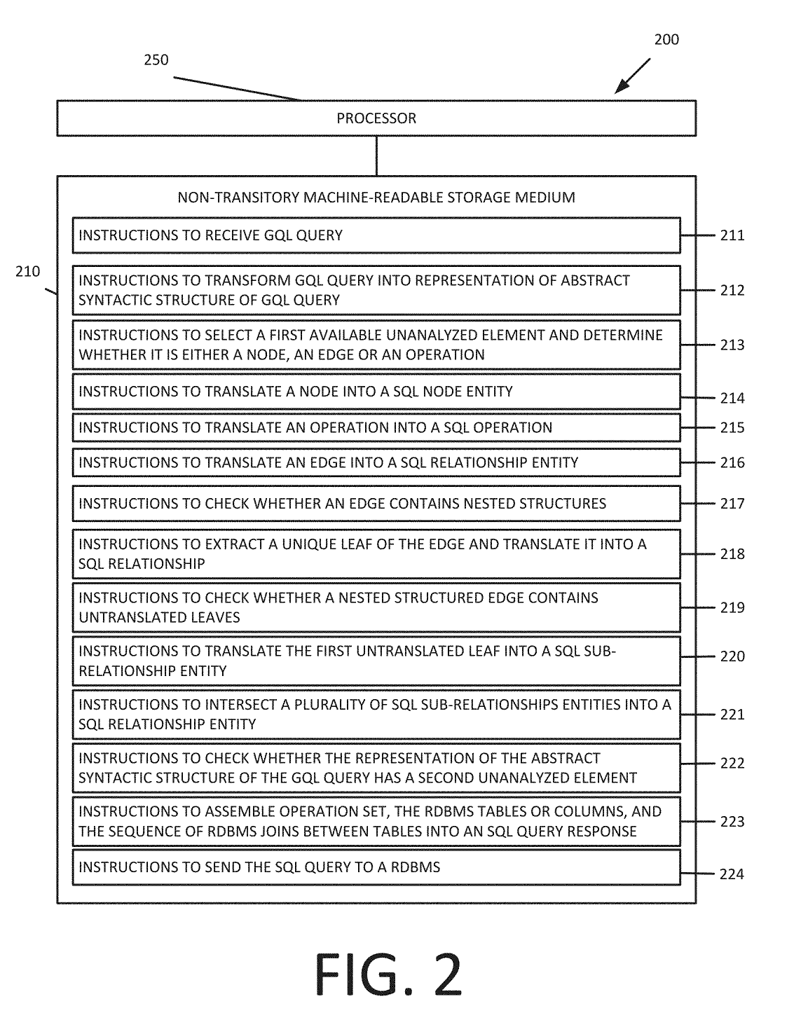

FIG. 2 is a block diagram illustrating additional instructions of the system 200 for translating a GQL query into a SQL query, according to an example of the present disclosure.

System 200 comprises a processor 250 and a non-transitory machine readable storing medium 210, which may be analogous in many respects to the processor 120 and the medium 110, respectively. The non-transitory machine readable storing medium 210 comprises instructions to receive GQL query 211; instructions to transform GQL query into representation of abstract syntactic structure of GQL query 212; instructions to select a first available unanalyzed element and determine whether it is either a node, an edge or an operation 213; instructions to translate a node into a SQL node entity 214; instructions to translate an operation into a SQL operation 215; instructions to translate an edge into a SQL relationship entity 216; instructions to check whether an edge contains nested structures 217; instructions to extract a unique leaf of the edge and translate it into a SQL relationship 218; instructions to check whether a nested structured edge contains untranslated leaves 219; instructions to translate the first untranslated leaf into a SQL sub-relationship entity 220; instructions to intersect a plurality of SQL sub-relationships entities into a SQL relationship entity 221; instructions to check whether the representation of the abstract syntactic structure of the GQL query has a second unanalyzed element 222; instructions to assemble the operation set, the RDBMS tables or columns, and the sequence of RDBMS joins between tables into an SQL query response 223; and instructions to send the SQL query to a RDBMS 224; and/or other instructions to translate a GQL query into a SQL query. Instructions 212, 213, and 223 may be analogous in many respects to instructions 111, 112, and 114 respectively. In the implementation shown in FIG. 2, instructions 213-223 may be sub-instructions of FIG. 1 instruction 113.

The instructions 211, when executed by the processor 250, may cause the processor 250 to receive the GQL query.

The instructions 212, when executed by the processor 250, may cause the processor 250 to transform the GQL query into a representation of abstract syntactic structure of GQL query. For example, the GQL query may be transformed into an AST using a Parser module.

The instructions 213, when executed by the processor 250, may cause the processor 250 to select a first unanalyzed element (e.g. the first unanalyzed element from the AST received by the execution of instructions 212). The instructions 213, when executed by the processor 250, may further cause the processor 250 to determine whether the first available unanalyzed element from the representation of abstract syntactic structure of GQL query (e.g. the first unanalyzed element from the AST received by the execution of instructions 212) is a node, an edge or an operation. In the present illustration, the AST generated by instructions 212 may include in each code line a breakdown of the GQL query into syntax elements, including nodes, edges or operations.

Nodes are elements that the user wants to extract information from. For example nodes may include the entities of the query, or classes of objects. Nodes may be the vertex in graph theory, and therefore the fundamental units of which graphs are formed. In databases, nodes may be either tables in the database, several tables in the database or a segment of a table in a database due to restrictions. For example in the query “How many computers have been sold by the company in the United States?”; “computers”, “the company”, and “the United States” may be nodes. As described herein, edges may be the relationships between the nodes in the query. Edges may be the relationships between vertices in graph theory. In database language, edges may be how database tables are linked together in order to answer the query. For example, in the query “How many computers have been sold by the company in the United States?”; “sold” may be an edge.

In the present disclosure, operations may be understood as a query execution plan, that is, an ordered set of steps used to access data in a relational database management system. In other words, operations may be directions that the user provides in the GQL declarative language in order to perform actions on the results. Because there may be multiple ways to access a database, operations set the proper path to perform this task. The same operation may have different commands in GQL and in SQL.

The instructions 214, when executed by the processor 250, may cause the processor 250 to translate the node (e.g. node received by execution of instructions 213) into a SQL node entity using the GQL-to-SQL dictionary file. The GQL-to-SQL dictionary may be referred herein as gTop.

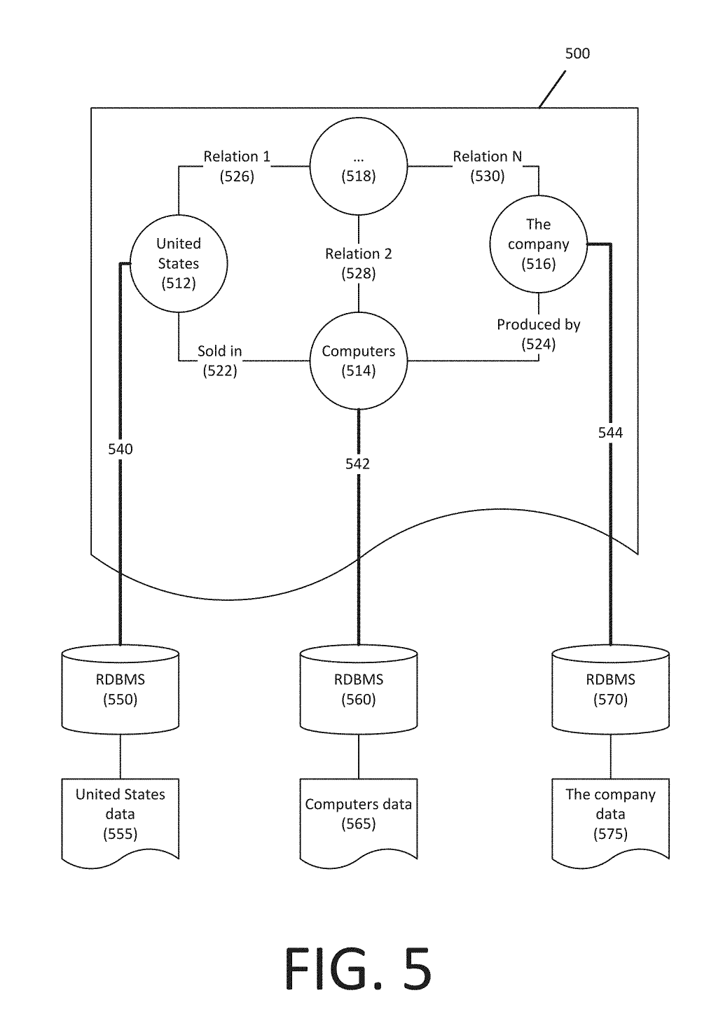

FIG. 5 is an illustration of a GQL-to-SQL dictionary, according to an example of the present disclosure. FIG. 5 describes an example of a GQL-to-SQL dictionary 500 that comprises a graph topology and a plurality of GQL-to-SQL connections. The graph topology from the GQL-to-SQL dictionary 500 may comprise a plurality of node entities (United States node 512, Computers node 514, The company node 516, and other nodes 518), a plurality of edges (an edge 522 that shows the relationships between node 512 and node 514 with “sold in” attribute, an edge 524 that shows the relationships between node 514 and node 516 with “produced by” attribute, an edge 526 that shows the relationships between node 512 and a not shown node 518 with “Relation 1” attribute, an edge 528 that shows the relationships between node 514 and a not shown node 518 with “Relation 2” attribute, and an edge 530 that shows the relationships between node 516 and a not shown node 518 with “Relation N” attribute). The GQL-to-SQL connections from the GQL-to-SQL dictionary 500 may further comprise connection 540 that links node 512 with the RDBMS 550, connection 542 that links node 514 with RDBMS 560, and connection 544 that links the node 516 with RDBMS 570. FIG. 5 may also comprise a plurality of connections (not shown) that may link to every node of other nodes 518. FIG. 5 further comprises a plurality of RDBMS, three RDBMS are shown (RDBMS 550, RDBMS 560, and RDBMS 570) but the present disclosure could use any amount of RDBMS greater than zero. Each RDBMS may comprise a dataset (RDBMS 550 comprises United States data 555, RDBMS 560 comprises Computer data 565, and RDBMS 570 comprises The company data 575).

Each connection (540, 542, 544) may map information from the node to the RDBMS. For example, connection 540 may map information from node 512 to the RDBMS 550, connection 542 may map information from node 514 to the RDBMS 560, and connection 544 may map information from node 516 to the RDBMS 570. The process of mapping information from a node to a RDBMS may be performed by the name of the table and then the attributes may be the columns of the selected database. For example, node 512 name is “United States” and therefore connection 540 may map node 512 information to the “United States data” 555 from RDBMS 550.

The GQL-to-SQL dictionary file may be built at the beginning of the method 400 manually or automatically. In the present disclosure, if the GQL-to-SQL dictionary file is built manually may be understood, for example, as if an expert may write the graph topology dependencies by hand. If the GQL-to-SQL dictionary file is built automatically may indicate, for example, that a plurality of machine learning instructions may write the functional dependencies in the columns of the RDBMS to infer to the graph topology. If the RDBMS is updated, the graph topology file may be updated as well. The graph topology update may be performed manually or automatically as well.

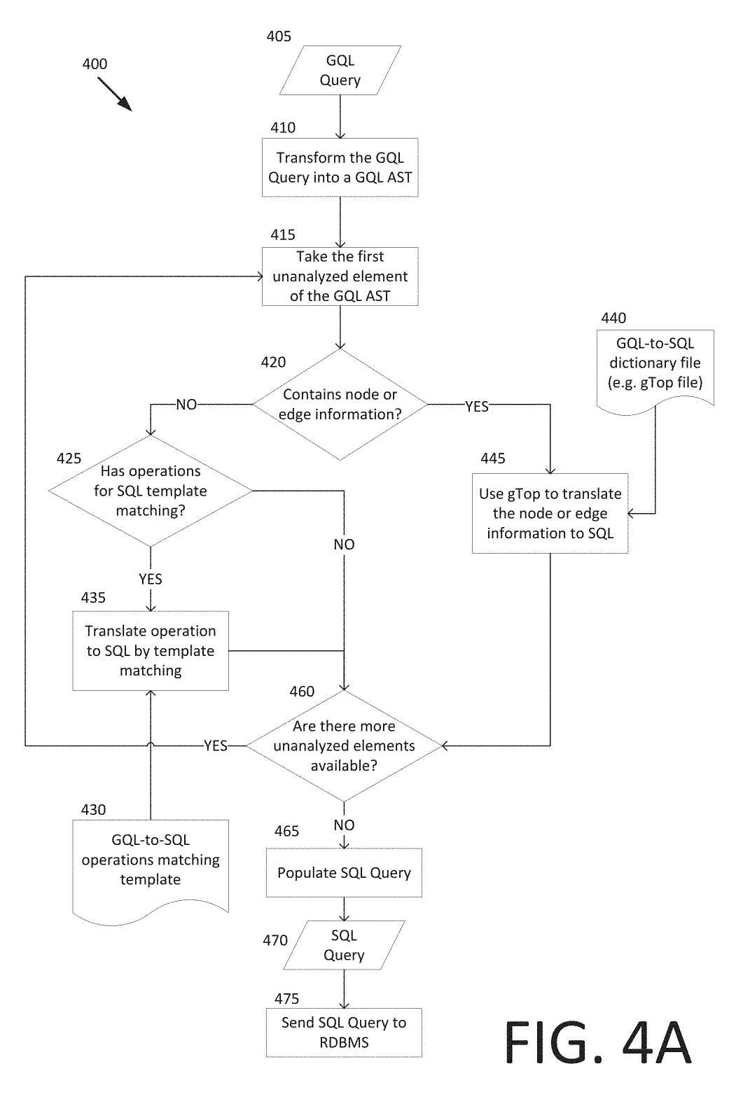

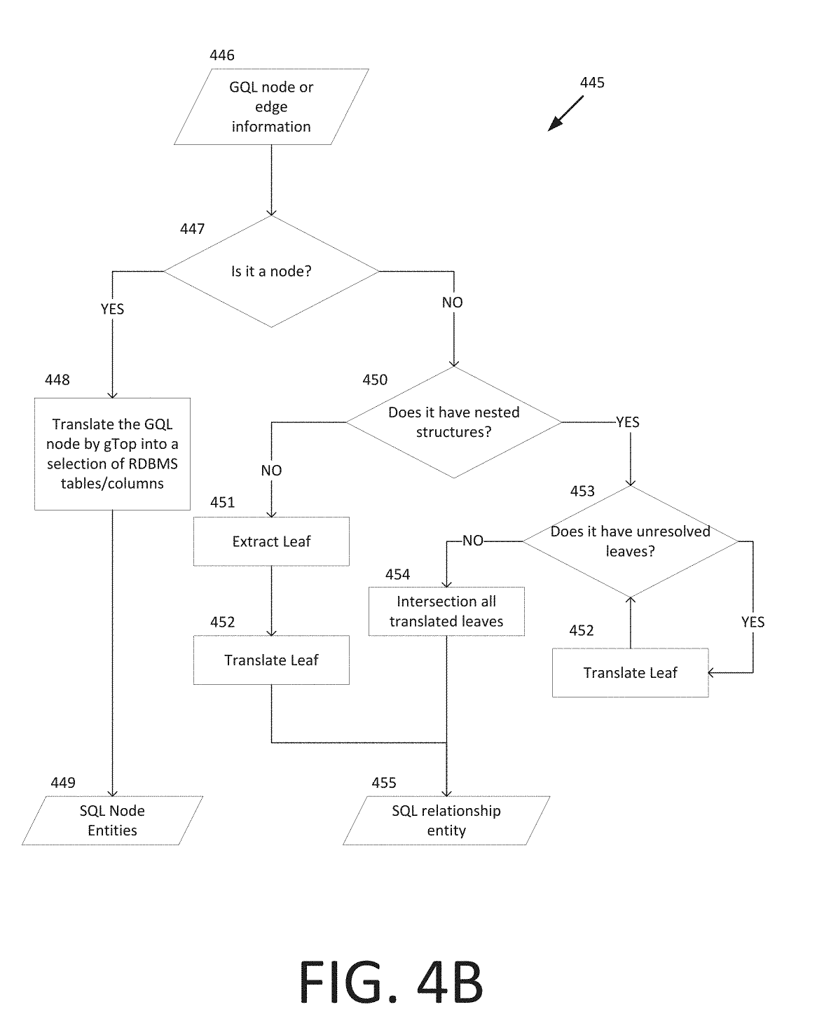

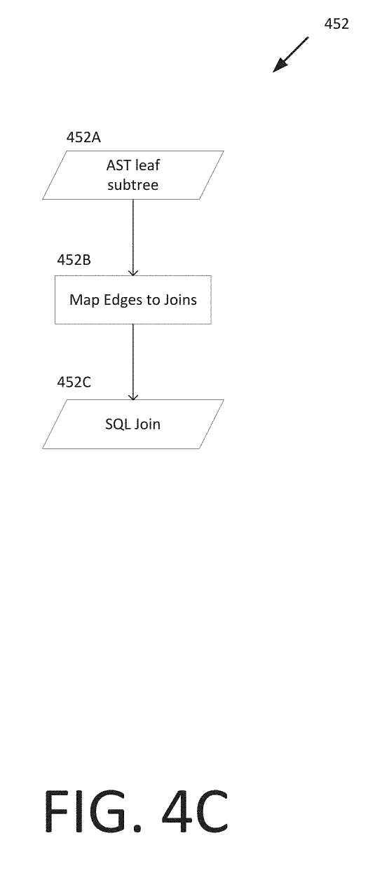

Turning to FIG. 4A, the instructions 215, when executed by the processor 250, may cause the processor 250 to translate the operation (e.g. operation received by execution of instructions 213) into a SQL operation using the GQL-to-SQL operations matching template. For example, the GQL-to-SQL operation matching template may be a file that contains the translation for any operation in both, GQL and SQL. In some cases, translation or mapping from a GQL operation to a SQL operation may be one-to-one or not one-to-one (e.g., one-to-many). Using the GQL-to-SQL operation matching template, the processor 250 may translate every operation or set of GQL operations into a set of one or more SQL operations.

There may be a plurality of ways to translate a GQL operation into a one or more SQL operations. The following table is an example of the GQL-to-SQL matching template. It shows GQL query language operations and the according translation into SQL querying language. There are some operations that the GQL-to-SQL translation do not change, for example “Limit”. However there are other GQL operations that do change when translated to SQL, for example “Match” and “return” change to “Select” and “ ” respectively.

| GQL operation | SQL operation |
|---|---|
| Match | Select |
| n:Person | FROM Person |
| Return | — |
| Limit | Limit |
| n.name | person.name |

The instructions 216, when executed by the processor 250, may cause the processor 250 to translate the edge (e.g. edge received by execution of instructions 213) into a SQL relationship entity using the GQL-to-SQL dictionary.

The instructions 217, when executed by the processor 250, may cause the processor 250 to determine whether an edge (e.g. edge received by execution of instructions 213) contains nested structures.

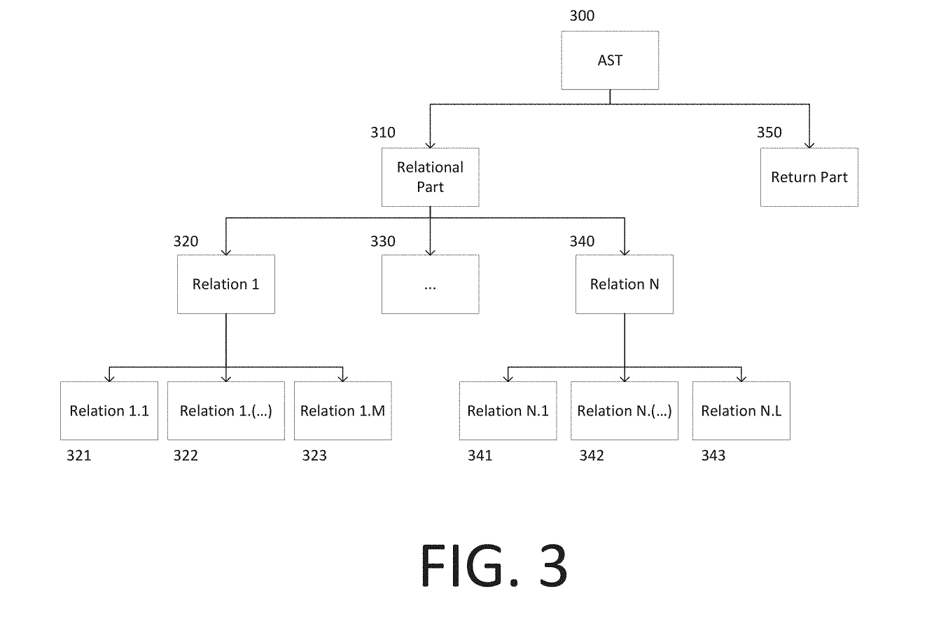

Instructions 217 will now be described in greater detail with reference to FIG. 3. FIG. 3, is a schema of an example abstract syntax tree 300 structure breakdown that includes nested structures of the edge or relational structure. The relational part of an AST 310 may comprise a plurality of different relations, for example from Relation 1 (320) to Relation N (340). In the previous first example, the user queried “How many computers have been sold by the company in the United States?”. In that example, Relation 1 may be “computers sold by the company” and Relation 2 “computers sold in the United States”. On top of that, each relation may be based on a plurality of sub-relationships. FIG. 3 shows that Relation 1 (320) is based on M sub-relationships which comprise from Relation 1.1 (321) to Relation 1.M (323); and Relation N (340) is based on L sub-relationships which comprise from Relation N.1 (341) to Relation N.L (343). N, M and L are integer positives. As a second example, in the query “Students that are eligible to enroll a course”, Relation 1 may be “to be eligible”, and Relation 1 sub-relationships may be, for example, Relation 1.1 “that is enrolled to the university”, Relation 1.2 “that has passed the previous course”, Relation 1.3 “that the course is eligible from the student curriculum”, etc.

In the present disclosure the term “Leaf” may be understood as the lowest level relationships or sub-relationships, or a combination thereof, that comprise the relational part of an AST. The first example may have 2 leaves: “computers sold by the company” and “computers sold in the United States” which are two relationships. The second example may have 3 leaves: “that is enrolled to the university”, “that has passed the previous course” and “that the course is eligible from the student curriculum”; while the relationship “to be eligible” may not be considered a leaf as it is not in the relationship tree lowest level. A third example may have leaves in both the first relationship level and the second sub-relationship levels. A fourth example may have leaves in a lower level than the second sub-relationship levels, such as a third sub-relationship level (sub-relationship from a sub-relationship).

Turning back to FIG. 2, the instructions 218, when executed by the processor 250, may cause the processor 250 to extract a unique leaf of the edge (e.g. edge received by execution of instructions 213) and translate it into a SQL relationship entity using the GQL-to-SQL dictionary file.

The instructions 219, when executed by the processor 250, may cause the processor 250 to check whether a nested structured edge contains untranslated leaves.

The instructions 220, when executed by the processor 250, may cause the processor 250 to translate the first untranslated leaf (e.g. unique leaf received from execution of instructions 218, first untranslated leaf received from execution of instructions 219) into a SQL sub-relationship entity using the GQL-to-SQL dictionary file.

The instructions 221, when executed by the processor 250, may cause the processor 250 to intersect a plurality of SQL sub-relationships entities (e.g. received by execution of instructions 220) into a SQL relationship entity using, for example, a “UNION ALL” command on the plurality of SQL sub-relationships.

The instructions 222, when executed by the processor 250, may cause the processor 250 to check whether the representation of the abstract syntactic structure of the GQL query (e.g. received from instructions 212) has a second unanalyzed element. Instructions 222 may be responsible to check that, for example, every code line from the AST has been analyzed and translated (or mapped) into SQL.

The instructions 223, when executed by the processor 250, may cause the processor 250 to assemble the operation set, the RDBMS tables or columns, and the sequence of RDB joins between tables into an SQL query response.

Prior to assembling the SQL query, instructions 223 may also be responsible to intersect all SQL operations (generated by instructions 215) into a SQL operation set, to map SQL node entities to the RDBMS tables or columns, and map all the SQL relationships entities to a RDBMS joins between tables. Further, instructions 223 may assemble the operation set, the RDBMS tables or columns, and the sequence of RDBMS joins between tables into an SQL query response.

The instructions 224, when executed by the processor 250, may cause the processor 250 to send the SQL query to the relational database management system.

FIG. 4A is a flowchart for a method 400 for translating a GQL query 405 into a SQL query 470, according to an example of the present disclosure. FIG. 4A may be performed by processor 250 from system 200. For example, a user may wish to request some specific data from a RDBMS that natively operates with SQL, and the user may write a GQL Query 405 in either imperative or declarative GQL language. However, in the following example the user may have queried in declarative GQL language. Therefore, GQL Query 405 may be the input of the method 400.

At block 410, the processor 250 may transform the GQL query 405 into a GQL AST. More particularly, block 410 may include breaking down GQL query syntactic entities, such as nodes, edges, and operations into independent code lines for further analysis. Other representations of an abstract syntactic structure of a GQL query may be used and AST is merely an example.

Once the AST is built, there may be a plurality of code lines or unanalyzed elements to be identified, analyzed and then translated. At block 415, the processor 250 may take the first unanalyzed element of the GQL AST and at block 420, the processor 250 may decide whether that unanalyzed element either contains node or edge information, or not.

If the first unanalyzed element contains node or edge information, a GQL-to-SQL dictionary file 440, at block 445 the processor 250 may translate the node or edge information to SQL. An example of block 445 which may translate the node or edge information from GQL to SQL is disclosed with further detail in FIG. 4B.

If the first unanalyzed element does not contain node or edge information, may indicate that the first unanalyzed element may be an operation, therefore at decision block 425 the processor 250 may further determine whether the first unanalyzed element has operations for SQL template matching. If the first unanalyzed element contains operations for SQL template matching, at block 435 the processor 250 may translate the first unanalyzed element to SQL by template matching using, for example, a GQL-to-SQL operations matching template 430.

Once the first unanalyzed element is translated to SQL, at decision block 460 the processor 250 may determine whether there are more unanalyzed elements available in the GQL AST. If there is a second unanalyzed element, the processor 250 may perform again block 415 by taking the second unanalyzed element of the AST and using the same method as the first unanalyzed element, the processor 250 may translate the second unanalyzed element to SQL (blocks 415-460). The unanalyzed elements translating to SQL loop (i.e., blocks 415, 420, 425, 435, 445, and 460). The translation loop (blocks 415-460) may end if there are no further unanalyzed elements available in the AST.

If there are not more unanalyzed elements available (i.e., all the AST elements are analyzed), at block 465 the processor 250 may populate the SQL query 470. At block 465, the processor 250 may intersect all SQL operations into an SQL operation set, may also map SQL node entities to the RDBMS tables or columns, and may also map SQL relationship entities to a sequence of RDBMS joins between tables. Then, the processor 250 may build the SQL query 470 by assembling the SQL operations set, the RDBMS tables or columns, and the sequence of RDBMS joins between tables.

Once the SQL query 470 is built, at block 475 the processor 250 may send the SQL query 470 to the RDBMS (i.e. RDBMS 150). The RDBMS may execute the SQL query and may forward the answer with the requested data back to the user.

In the example of FIG. 4B, the method 445 may take for example the GQL node or edge information 446 input (e.g. as shown in FIG. 4A) for use with gTop to translate the node or edge information to SQL 390. FIG. 4B is a flowchart for a method 445 for using gTop to translate the node or edge information to SQL, according to an example of the present disclosure. FIG. 4B may be performed by processor 250 from system 200.

At decision block 447, the processor 250 may determine whether the GQL node or edge information is either a node or an edge.

If GQL node or edge information is a node, at block 448 the processor 250 may translate the GQL node into SQL node entities. In order to perform block 448, processor 250 may access to a GQL-to-SQL dictionary file 440, such as gTop, and may map the GQL node into the corresponding selection of RDBMS tables, columns, or a combination thereof. In the present disclosure, the corresponding selection of RDBMs tables, columns, or a combination thereof; may also be known as SQL node entities 449.

If GQL node or edge information is an edge, at block 450 the processor 250 may determine whether the edge contains nested structures.

If the edge does not contain nested structures may imply that the edge contains a unique leaf. In that case, at block 451 the processor 250 may extract the leaf and at block 452 the processor 250 may translate the leaf into a SQL relationship entity 455.

If the edge contains nested structures may imply that the edge contains a plurality of leaves. In that case, at decision block 453 the processor 250 may determine whether the nested-structured edge contains unresolved leaves. Unresolved leaved may be understood as if the nested-structured edge contains leaves that are not translated, or resolved, to SQL.

If the nested-structured edge contains unresolved leaves, at block 452 the processor 250 may translate the first untranslated leaf into SQL. Then, processor 250 may perform decision block 453 again up to the point that there are no more unresolved leaves or, which may imply that all the leaves from the nested-structured edge have been translated. In that case, at block 454, the processor 250 may intersect all the translated leaves into a SQL relationship entity 455.

In the example of FIG. 4C, the method 452 may take for example the extracted unique leaf or an unresolved leaf (e.g. block 395 extracted unique leaf, block 397 unresolved leaf), hereinafter renamed as AST leaf subtree 452A. FIG. 4C is a flowchart for a method 396 for translating a leaf, according to an example of the present disclosure. FIG. 4C describes a AST leaf subtree input 396A, a map edges to joins block 396B and a SQL join output 396C. FIG. 4C may be performed by processor 250 from system 200.

At block 452B, processor 250 may map edges to joins, therefore outputting an SQL Join 452C.

The above described programmed hardware referred as system 100 for translating a GQL query into a SQL query may implement the system engines as disclosed in the following example.

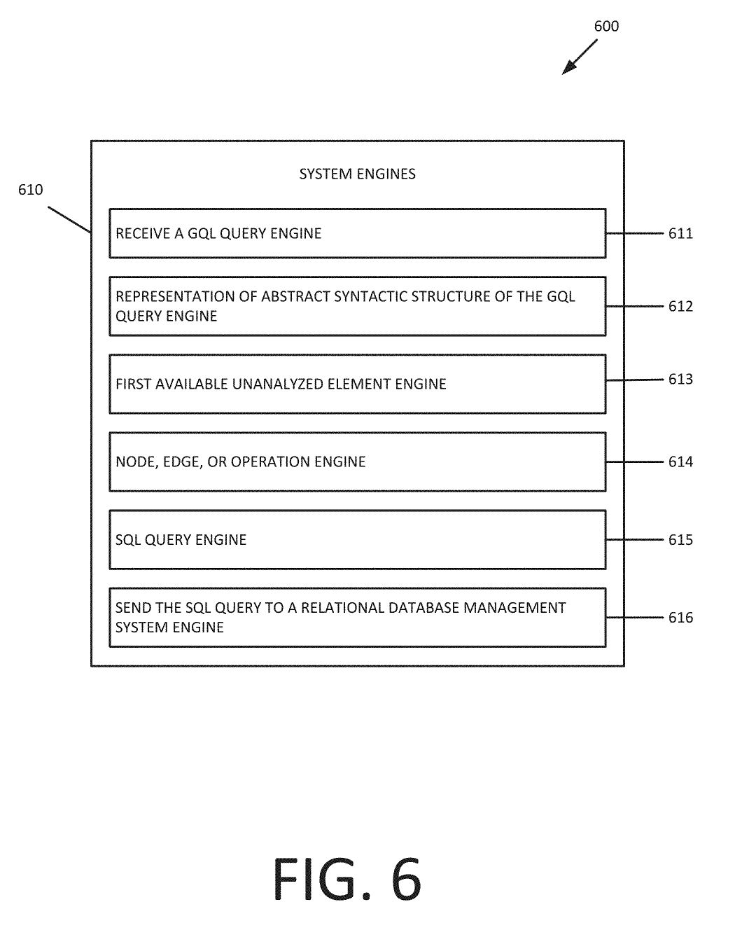

FIG. 6 is a block diagram illustrating a system 600 for translating a SQL query into a SQL query, according to an example of the present disclosure.

The system 600 of the disclosed example comprises a set of engines 610. Each of the engines may be implemented by computing hardware, or a combination of computing hardware and programming. In some examples, the system 600 may implement the functionality described in FIG. 1.

The system 600 comprises: a receive a GQL query engine 611; a representation of abstract syntactic structure of the GQL query engine 612; a first available unanalyzed element engine 613; a node, edge, or operation engine 614; a SQL query engine 615; and a send the SQL query to a relational database management system engine 616.

The receive a GQL query engine 611 executes the instructions to receive GQL query, either in imperative GQL language or declarative GQL language. The receive a GQL query engine 611 may perform this functionality in a manner similar to or the same as the instructions to receive GQL query 111 as described above in respect of FIG. 1.

The representation of abstract syntactic structure of the GQL query engine 612 executes the instructions to transform the GQL query into a representation of abstract syntactic structure. The representation of abstract syntactic structure of the GQL query engine 612 may perform this functionality in a manner similar to or the same as the instructions to transform GQL query into representation of abstract syntactic structure of GQL query 112 as described above in respect of FIG. 1.

The first available unanalyzed element engine 613 executes the instructions select the first available unanalyzed element from the representation of the abstract syntactic structure of the GQL query. The first available unanalyzed element engine 613 may perform this functionality in a manner similar to or the same as the instructions to translate representation of abstract syntactic structure of GQL query into SQL query 113 as described above in respect of FIG. 1.

The node, edge, or operation engine 614 executes the instructions to determine whether the first unanalyzed element from the representation of abstract syntactic structure of the GQL query is either a node, a relationship, or an operation. The node, edge, or operation engine 614 may perform this functionality in a manner similar to or the same as the instructions to translate representation of abstract syntactic structure of GQL query into SQL query 113 as described above in respect of FIG. 1.

The SQL query engine 615 executes the instructions to translate the representation of the abstract syntactic structure of the GQL query into a structured query language (SQL) query. The SQL query engine 615 may perform this functionality in a manner similar to or the same as the instructions to translate representation of abstract syntactic structure of GQL query into SQL query 113 as described above in respect of FIG. 1.

The send the SQL query to a relational database management system engine 616 executes the instructions to send the SQL query to a relational database management system. The send the SQL query to a relational database management system engine 616 may perform this functionality in a manner similar to or the same as the instructions to send the SQL query to a relational database management system 114 as described above in respect of FIG. 1.

The above described system for translating a GQL query into a GQL query may implement the method disclosed in the following example.

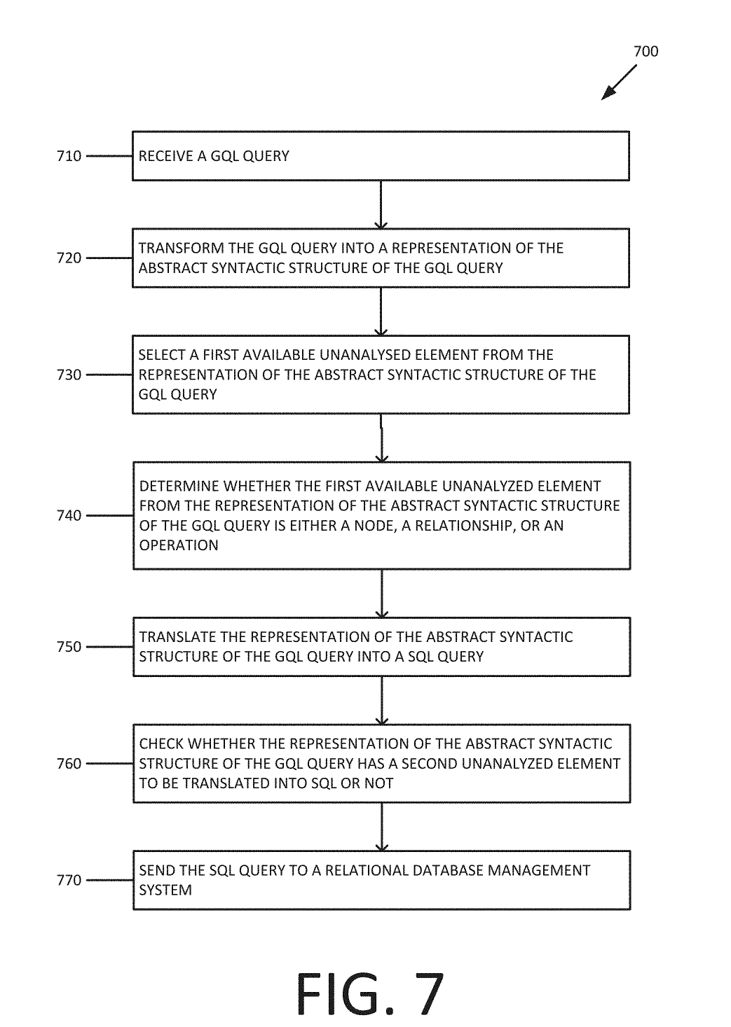

FIG. 7 is a flowchart illustrating a method 700 for translating a GQL query into a GQL query, according to an example of the present disclosure. Method 700 as well as the methods described herein can, for example, be implemented in the form of machine readable instructions stored on memory of a computing system (see, e.g., the implementation of FIG. 6), executable instructions stored on a non-transitory machine readable storage medium (see, e.g., the implementation of FIG. 1), in the form of electronic circuitry, or another suitable form.

At block 710, the method 700 receives a GQL query. For example system 100 (via instructions 111) may receive a GQL query. The system 100 may receive a GQL query in a manner similar or the same as the described above in relation to the execution of GQL query 405.

At block 720, the method 700 transforms the GQL query into a representation of the abstract syntactic structure of the GQL query. For example system 100 (via instructions 112) may transforms the GQL query into a representation of the abstract syntactic structure of the GQL query. The system 100 may transform the GQL query into a representation of the abstract syntactic structure of the GQL query in a manner similar or the same as the described above in relation to the execution of transform the GQL query into a GQL AST 410.

At block 730, the method 700 selects a first available unanalyzed element from the representation of the abstract syntactic structure of the GQL query. For example system 100 (via instructions 113) may select a first available unanalyzed element from the representation of the abstract syntactic structure of the GQL query. The system 100 may select a first available unanalyzed element from the representation of the abstract syntactic structure of the GQL query in a manner similar or the same as the described above in relation to the execution of take the first unanalyzed element of the GQL AST 415.

At block 740, the method 700 determines whether the first available unanalyzed element from the representation of the abstract syntactic structure of the GQL query is either a node, a relationship, or an operation. For example system 100 (via instructions 113) may determine whether the first available unanalyzed element from the representation of the abstract syntactic structure of the GQL query is either a node, a relationship, or an operation. The system 100 may determine whether the first available unanalyzed element from the representation of the abstract syntactic structure of the GQL query is either a node, a relationship, or an operation in a manner similar or the same as the described above in relation to the execution of contains node or edge information 420, has operations for SQL template matching 425, and is it a node 447.

At block 750, the method 700 translates the representation of the abstract syntactic structure of the GQL query into a SQL query. For example system 100 (via instructions 113) may translate the representation of the abstract syntactic structure of the GQL query into a SQL query. The system 100 may translate the representation of the abstract syntactic structure of the GQL query into a SQL query in a manner similar or the same as the described above in relation to the translate operation to SQL by template matching 435, use gTop to translate the node or edge information to SQL 445, populate SQL query 465, translate the GQL node by gTop into a selection of RDBMS tables/columns 448, does it have nested structures 450, extract leaf 451, translate leaf 452, does it have unresolved leaves 453, intersection all translated leaves 454, and map edges to joins 452B.

At block 760, the method 700 checks whether the representation of the syntactic structure of the GQL query has a second unanalyzed element to be translated into SQL or not. For example system 100 (via instructions 113) may check whether the representation of the syntactic structure of the GQL query has a second unanalyzed element to be translated into SQL or not. The system 100 may check whether the representation of the syntactic structure of the GQL query has a second unanalyzed element to be translated into SQL or not in a manner similar or the same as the described above in relation to the execution of are there more unanalyzed elements available 400.

At block 770, the method 700 send the SQL query to a relational database management system. For example system 100 (via instructions 114) may send the SQL query to a relational database management system. The system 100 may send the SQL query to a relational database management system in a manner similar or the same as the described above in relation to the execution of send SQL query to RDBMS 475.

The above examples may be implemented by hardware, firmware, or a combination thereof. For example the various methods, processes and functional modules described herein may be implemented by a physical processor (the term processor is to be interpreted broadly to include CPU, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, methods and functional modules are implemented as machine readable instructions executable by at least one processor, hardware logic circuitry of the at least one processors, or a combination thereof.

The drawings in the examples of the present disclosure are some examples. It should be noted that some units and functions of the procedure are not necessarily essential for implementing the present disclosure. The units may be combined into one unit or further divided into multiple sub-units.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

What is claimed is:

1. A non-transitory machine-readable medium storing machine-readable instructions executable by a processor to cause the processor to:
receive a graph query language (GQL) query, wherein the GQL query is a declarative GQL query;
transform the GQL query into a representation of an abstract syntactic structure of the GQL query;
translate the representation of the abstract syntactic structure of the GQL query into a structured query language (SQL) query; and
send the SQL query to a relational database management system.

2. The non-transitory machine-readable medium of claim 1, further comprising machine readable instructions that are executable by the processor to cause the processor to:
select a first available unanalyzed element from the representation of the abstract syntactic structure of the GQL query; and
determine whether the first available unanalyzed element from the representation of the abstract syntactic structure of the GQL query is either a node, a relationship, or an operation.

3. The non-transitory machine-readable medium of claim 2, further comprising machine readable instructions that are executable by the processor to cause the processor to:
upon determining that the first available unanalyzed element from the representation of the abstract syntactic structure of the GQL query is a node,
access a GQL-to-SQL dictionary file; and
translate the node into a SQL node entity using the GQL-to-SQL dictionary file.

4. The non-transitory machine-readable medium of claim 2, further comprising machine readable instructions that are executable by the processor to cause the processor to:
upon determining that the first available unanalyzed element from the representation of the abstract syntactic structure of the GQL query is an operation,
access a GQL-to-SQL operations matching template; and
translate the operation into a SQL operation using the GQL-to-SQL operations matching template.

5. The non-transitory machine-readable medium of claim 2, further comprising machine readable instructions that are executable by the processor to cause the processor to:
upon determining that the first available unanalyzed element from the representation of the abstract syntactic structure of the GQL query is an edge,
access a GQL-to-SQL dictionary file; and
translate the edge into a SQL relationship entity using the GQL-to-SQL dictionary file.

6. The non-transitory machine-readable medium of claim 5, further comprising machine readable instructions that are executable by the processor to check whether the edge contains nested structures.

7. The non-transitory machine-readable medium of claim 6, further comprising machine readable instructions that are executable by the processor and cause the processor to:
in response to a determination that the edge does not contain nested structures,
extract a unique leaf of the edge; and
translate the unique leaf of the edge into a SQL relationship entity using the GQL-to-SQL dictionary file.

8. The non-transitory machine-readable medium of claim 6, further comprising machine readable instructions that are executable by the processor that cause the processor to, in response to a determination that the edge contains nested structures, check whether the edge contains untranslated leaves.

9. The non-transitory machine-readable medium of claim 8 wherein the edge contains a plurality of untranslated leaves, further comprising machine readable instructions that are executable by the processor that cause the processor to translate a first untranslated leave from the plurality of untranslated leaves to a SQL sub-relationship entity using the GQL-to-SQL dictionary file.

10. The non-transitory machine-readable medium of claim 8 wherein the edge does not contain untranslated leaves, further comprising machine readable instructions that are executable by the processor that cause the processor to intersect a plurality of SQL sub-relationship entities into a SQL relationship entity.

11. The non-transitory machine-readable medium of claim 2 further comprising machine readable instructions that are executable by the processor that cause the processor to; in response to a determination that the first available unanalyzed element from the representation of the abstract syntactic structure of the GQL query is either a node, a relationship, or an operation; check whether the representation of the abstract syntactic structure of the GQL query has a second unanalyzed element to be translated into SQL or not.

12. The non-transitory machine-readable medium of claim 11, further comprising machine readable instructions that are executable by the processor to:
in response to a determination that the representation of the abstract syntactic structure of the GQL query has no further unanalyzed elements to be translated into SQL,
intersect all SQL operations into an SQL operations set;
map SQL node entities to the relational database management system tables or columns;
map SQL relationship entities to a sequence of relational database management system joins between tables; and
assemble the SQL operations set, the relational database management system tables or columns, and the sequence of relational database management system joins between tables into an SQL query response.

13. A system comprising:
a processor;
a non-transitory machine readable medium storing machine readable instructions to cause the processor to:
receive a graph query language (GQL) query, wherein the GQL query is a declarative GQL query;
transform the GQL query into a representation of the abstract syntactic structure of the GQL query;
select a first available unanalyzed element from the representation of the abstract syntactic structure of the GQL query;
determine whether the first available unanalyzed element from the representation of the abstract syntactic structure of the GQL query is either a node, a relationship, or an operation;
translate the representation of the abstract syntactic structure of the GQL query into a structured query language (SQL) query; and
send the SQL query to a relational database management system.

14. The system of claim 13, wherein the machine readable instructions further include instructions to cause the processor to:
upon determining that the first available unanalyzed element from the representation of the abstract syntactic structure of the GQL query is a node,
access a GQL-to-SQL dictionary file; and
translate the node into a SQL node entity using the GQL-to-SQL dictionary file.

15. The system of claim 13, wherein the machine readable instructions further include instructions to cause the processor to:
upon determining that the first available unanalyzed element from the representation of the abstract syntactic structure of the GQL query is an operation,
access a GQL-to-SQL operations matching template; and
translate the operation into a SQL operation using the GQL-to-SQL operations matching template.

16. The system of claim 13, wherein the machine readable instructions further include instructions to cause the processor to:
upon determining that the first available unanalyzed element from the representation of the abstract syntactic structure of the GQL query is an edge,
access a GQL-to-SQL dictionary file; and
translate the edge into a SQL relationship entity using the GQL-to-SQL dictionary file.

17. A method implemented by a computer system that includes a physical processor implementing machine readable instructions, the method comprising:
receiving a graph query language (GQL) query, wherein the GQL query is a declarative GQL query;
transforming the GQL query into a representation of the abstract syntactic structure of the GQL query;
selecting a first available unanalyzed element from the representation of the abstract syntactic structure of the GQL query;
determining whether the first available unanalyzed element from the representation of the abstract syntactic structure of the GQL query is either a node, a relationship, or an operation;
translating the representation of the abstract syntactic structure of the GQL query into a structured query language, SQL, query;
checking whether the representation of the abstract syntactic structure of the GQL query has a second unanalyzed element to be translated into SQL or not; and
sending the SQL query to a relational database management system.

18. The method of claim 17, further comprising:
upon determining that the first available unanalyzed element from the representation of the abstract syntactic structure of the GQL query is a node,
access a GQL-to-SQL dictionary file; and
translate the node into a SQL node entity using the GQL-to-SQL dictionary file.

19. The method of claim 17, further comprising:
upon determining that the first available unanalyzed element from the representation of the abstract syntactic structure of the GQL query is an operation,
access a GQL-to-SQL operations matching template; and
translate the operation into a SQL operation using the GQL-to-SQL operations matching template.

20. The method of claim 17, wherein the first available unanalyzed element from the representation of the abstract syntactic structure of the GQL query is an edge, further comprising:
upon determining that the first available unanalyzed element from the representation of the abstract syntactic structure of the GQL query is an edge,
access a GQL-to-SQL dictionary file; and
translate the edge into a SQL relationship entity using the GQL-to-SQL dictionary file.
